(19) United States
(12) Patent Application Publication
(10) Pub. No.: US 2025/0291743 A1
(43) Pub. Date: Sep. 18, 2025

(54) Management of Display Device Connected to Docking Station

(71) Applicant: Hewlett-Packard Development Company, L.P., Spring, TX (US)

(72) Inventors: Thong Thai, Spring, TX (US); Roger D. Benson, Spring, TX (US); Syed Yasir Abbas, Spring, TX (US)

(21) Appl. No.: 18/577,042

(22) PCT Filed: Jul. 7, 2021
(86) PCT No.: PCT/US2021/040721

§ 371 Date: Jan. 5, 2024

(51) Int. Cl. G06F 13/10; G06F 1/16; G06F 13/42

(52) U.S. Cl. CPC G06F 13/102; G06F 1/1632; G06F 13/4282

(57) ABSTRACT

A virtual control panel (VCP) protocol is established on top of the VESA standard DDC/CI protocol. The VCP protocol can establish direct communications between a dock management controller (DMC) of a docking station and a display device connected to the docketing station via a serial protocol (e.g., I2C). With the VCP protocol, the DMC can manage the display device with or without a host computer, such as, to wake up the display, to put it to sleep, to change brightness, to set video input port, etc.

### BACKGROUND

When a user unplugs a host computer from a docking station or when the host computer enters a sleep state, the display devices (or monitors) connected thereto normally enter a sleep state to conserve energy. When the host computer is plugged into the docking station or when the host computer wakes up, there is a latency to wake up the display devices from the sleep state. Such latency can be significant, because conventionally the docking station must scan incoming video signals for each of its input ports. Measurements have shown that it takes an overall latency of up to 20 seconds from wake to active image. This latency may cause miscommunications resulting in some or all the display devices not being activated. That is, host enumeration of the display devices may fail, if one or more of the display devices are still in a sleep state and thus not being responsive to the requests from the host computer.

### BRIEF DESCRIPTION OF THE DRAWINGS

FIGS. 1A and 1B schematically illustrate the management of display devices connected to a docking station in accordance with an example.

FIG. 2 is a flow chart illustrating a process of the management of display devices connected to a docking station in accordance with an example.

### DETAILED DESCRIPTION

In one aspect, this disclosure provides a mechanism to wake up one or more display devices connected to a docking station as soon as a host computer docks or wakes up. The docking station can configure the input of the display devices to match with the video output of the host computer to avoid the need of scanning all the video input ports. In another aspect, the display devices can also wake up prior to the actual docking event (namely, pre-emptive wake). For example, if the user always starts using the display device every day at about 8:00:00 AM, the docking station can be configured to wake up the display devices at about 7:59:40 AM. Alternatively, the display devices may wake up when the user or the host computer approaches or is in close proximity (e.g., within 3 meters) to the docking station prior to the actual physical dock. This can be done by detecting the user's presence using, for example, a passive infrared (PIR) sensor of the docking station, or by detecting the presence of the host computer using, for example, a wireless/RF signal (e.g., Bluetooth) detector.

A docking station provides a host computer (e.g., laptop computer, smartphone, tablet, and/or gaming device, among others) with various peripherals devices (e.g., keyboard, display devices, speakers, cameras, etc.) and extension ports when the host computer is connected to the docking station, such that the host computer can function as a more powerful device. For example, when being connected to a docking station, a tablet can function as a laptop computer, and a laptop computer can function as a desktop computer. As such, a user can use a physical keyboard connected to the docking station to operate a tablet. Likewise, a use can use multiple display devices connected to the docking station to operate a laptop computer.

Further, a docking station can include multiple ports to communicate power and/or data with the peripheral devices. For example, the docking station can include a dedicated port to provide power and/or data to a host computer and another dedicated port to provide power and/or data to a peripheral device (e.g., a display device). That is, docking stations can permit a host computer and/or a peripheral device connected thereto to receive power from the docking station and to transfer data between the docking station and the host computer and/or the peripheral device.

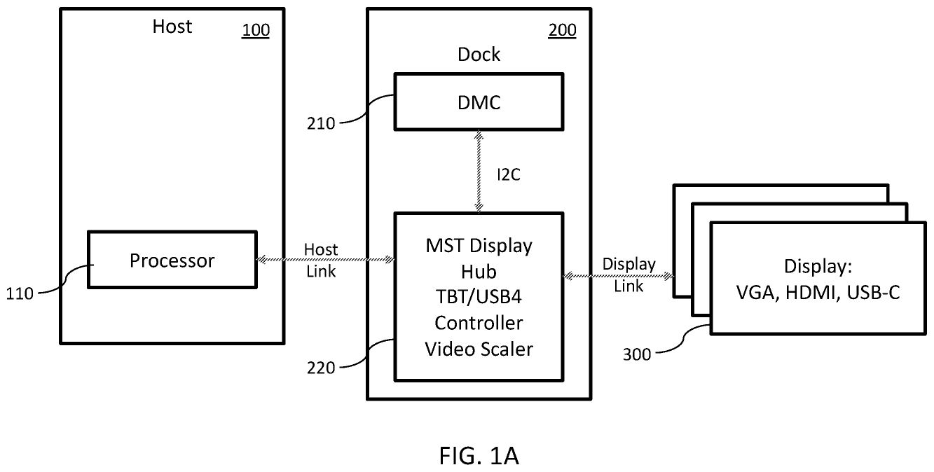

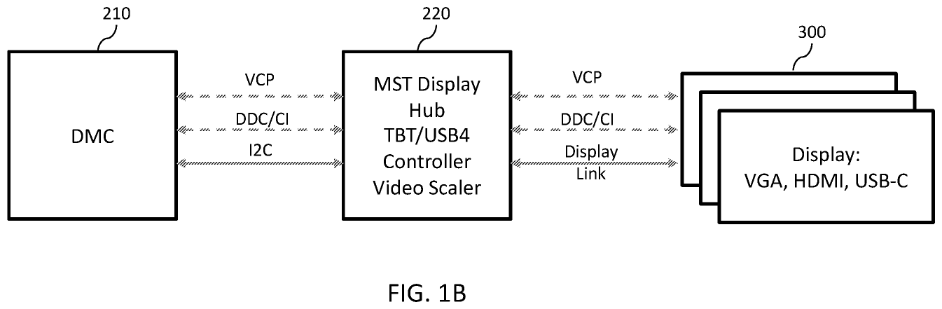

FIGS. 1A and 1B schematically illustrate the management of display devices 300 connected to a docking station 200 in accordance with an example. As shown in FIG. 1A, a host computer 100 including a processor 110 (e.g., CPU, GPU, etc.) can be docked with docking station 200 through a docking port. In one example, host computer 100 can be docked with docking station 200 by plugging host computer 100 to the docking port of docking station 200, which may then communicate power and data between host computer 100 and docking station 200. In another example, host computer 100 can be docked with docking station 200 wirelessly for data communication using, e.g., Bluetooth or other near field communication protocols. Upon docking of host computer 100, a host link is established to communicate data and/or power between host computer 100 and docking station 200.

Referring to FIG. 1A, docking station 200 includes a dock management controller (DMC) 210 and a multi-stream transport (MST) display hub 220 communicably coupled to DMC 210 through a serial communication interface (or serial data link), such as, I2C. In one example, DMC 210 is an integrated circuit hardware device including a plurality of serial communication blocks (SCB) to implement an I2C, SPI, or UART interface, and a general-purpose input/output (GPIO) controller to control a plurality of GPIO ports, thereby supporting various serial communication protocols. In a typical dock/monitor application, docking station 200 may also include a power delivery (PD) controller. DMC 210 may be connected to a PD controller and a hub controller through a SCB (such as, the I2C interface) and GPIOs. DMC 210 can communicate with the PD controller and the hub controller and detect/control their status. DMC 210 can also enable firmware updates over the SCB interface.

In one example, MST display hub 220 is a hardware device that receives video signals from processor 110 of host computer 100 via a first display link (e.g., DisplayPort, Mini DisplayPort, etc.), and transmits the video signals to one or more display devices 300 through one or more second display links (e.g., VGA, HDMI, USB-C, etc.). MST display hub 220 can mirror or duplicate the contents shown on the display device of host computer 100 so that the same contents can be shown on the display devices 300. MST display hub 220 can also extend the workable space (desktop) of host computer 100 to display devices 300. It is appreciated that, in other examples, any video output controller hardware (e.g., a thunderbolt controller, a USB4 controller, a video scaler, etc.) capable of supporting output video to display devices 300 can be used in placed of MST display hub 220.

MST display hub 220 may be powered down when host computer 100 is not attached and/or active. For MST display hub 220 to handle display change while being powered down, it needs the PD controller or DMC 210 to wake it up whenever there is a plug or unplug event of any display. A hardware circuitry can be used to generate an interrupt to the PD controller (or DMC if a general-purpose input/output (GPIO) controller is available) whenever there is a plug or unplug event of any display. The PD controller notifies DMC 210 of this change, which then wakes up MST display hub 220 to handle the notification. DMC 210 queries MST display hub 220 and updates a display connection profile based on this event.

To prevent the enumeration of monitors every time host computer 100 is plugged or docked into docking station 200, the display connection profile is set up to record the information on each of the connected display devices. The display connection profile can be stored in a memory of DMC 210 or in any other suitable memory devices. Below is an exemplary display connection profile in the form of a table to be further discussed below.

| Port | Serial Number | Active? | Timing |
|---|---|---|---|
| TX0 | EDID s/n | On/Off | HWIDTH, VWIDTH |
| TX1 | | | |
| TX2 | | | |

### Exemplary Display Connection Profile

When a display device 300 is connected to a display link (e.g., HDMI) of docking station 200, it become communicable with DMC 210 through one of its ports, e.g., TX0. In one example, immediately after display device 300 is connected, the display connection profile at the TX0 row records the serial number (e.g., Extended Display Identification Data, “EDID”) of the connected display device 300, the status of the ports (“On” or “Off), and the timing (HWDITH, AddEIGHT) of the output resolution of the connected display device 300. The serial number can be set to “0” if the port is not in use. The display connection profile can be updated whenever a new display device is connected to and discovered by docking station 200, or when an old display device is disconnected from docking station 200. It is appreciated that the display connection profile can be updated periodically with or without a host computer being attached.

Referring to FIG. 1B, in one example, direct communications can be established between DMC 210 and display devices 300 via, for example, the I2C interface, by creating a virtual control panel (VCP) path between DMC 210 and display devices 300. VCP is a VESA standard to control a display device from a host computer. In this example, the VCP path for direct communications between DMC 210 and display devices 300 is built on top of VESA standard DDC/CI protocol. With this VCP path, DMC 210 can send “VCP read/write commands” to manage display devices. As such, through this VCP path, DMC 210 may wake up display devices 300, put them to sleep, change their brightness, set the video input ports, set input of display device 300, set the power state of display device 300, etc., with or without host computer 100. The VCP path between DMC 210 and display devices 300 can be leveraged for future display performance optimization and use cases.

VCP code can be a 1-byte value used for implementing read and write commands on monitors supporting the DDC/CI protocol. VCP codes ranging from 0x00 to 0xDF are reserved for standard codes by VESA. Codes ranging from 0xEO to 0xFF (32 codes) are custom codes that can be implemented by display manufacturers and considered as proprietary features. Each VCP code has a value associated with it. The standard defines that a few read commands use a 4-byte value to be associated with them. All other read commands and all write commands are associated with a 2-byte value. This disclosure uses one or more of the codes ranging from 0xEO to 0xFF to build the direct communications between DMC 210 and display devices 300.

DCC/CI is a set of protocols based on the I2C interface and used on a bi-directional data channel between display devices 300 and host computer 100. The protocols provide a mechanism to send commands to display devices 300. Additionally, data may also be sent to or received from display devices 300. Additional details can be found in the VESA DDC/CI Standard.

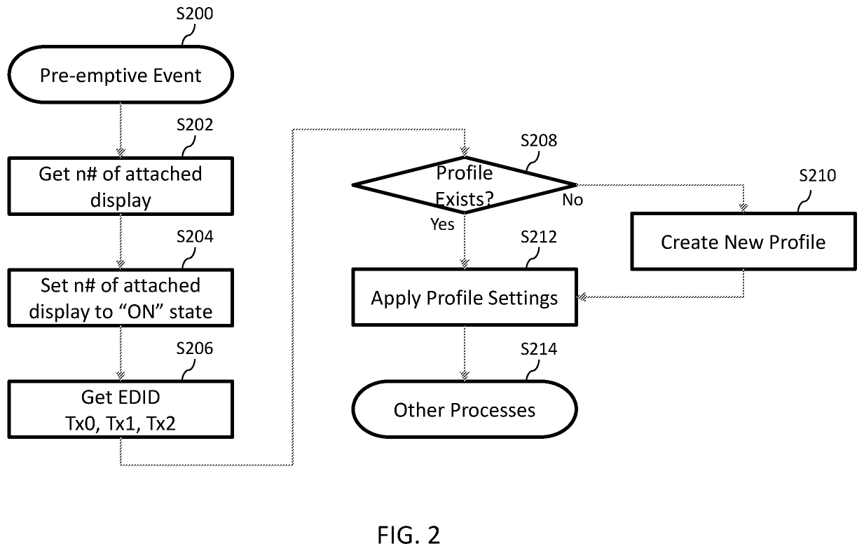

FIG. 2 is a flow chart illustrating a process of the management of display devices connected to a docking station in accordance with an example.

In Step S200, the display device management process begins from a pre-emptive event detected by docking station 200. The pre-emptive event can include: (1) host computer 100 is docked; (2) host computer 100 wakes from a sleep state while docked; (3) host computer is cold boot while docked; and (4) docking station 200 receives a wireless signal (e.g., Bluetooth Beacon) from host computer 100 to be docked.

In Step S202, in response to the pre-emptive event, DMC 210 executes a command “GetNumMonitor” to retrieve information on the quantity of display devices 300 that are connected to docking station 200.

In Step S204, DMC 210 executes a command “SetMonitorPowerState” to set the power state of the connected display devices 300 to an “On” state.

In Step S206, DMC 210 executes a command “GetMonitorSerialNumber” to retrieve respective serial numbers of the connected display devices 300.

In Step S208, DMC 210 executes a command “GetMonitorProfile” to retrieve a profile. If a profile does not exist, the command returns an error message, and the process continues to Step S210. If a profile exists, DMC 210 retrieves the profile, and the process continues to Step S212.

In Step S210, DMC 210 executes a command “Save Monitor Settings” to create a new profile and save it in a memory of DMC 210.

In Step S212, DMC 210 executes a command “SetMonitorInputSelect” to set the current input select and apply the profile to designated display devices 300.

In Step S214, the display device management process ends and DMC 210 proceeds to perform other processes.

It is appreciated that, unless specifically stated otherwise, the above Steps S200 through S214 are not necessarily sequential and may be executed in any appropriate order.

Some or all of the steps and/or functions described above may be implemented as computer readable instructions executable by a processor and stored in a non-transitory computer readable memory or storage medium, where the term “non-transitory” does not encompass transitory propagating signals. Such computer readable instructions may exist as a software program in form of source code, object code, executable code, or other formats.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

1. A docking station, comprising:
a host link communicable with a host computer;
a display link communicable with a display device;
a dock management controller comprising a serial data link; and
a virtual control panel protocol to facilitate direct communications between the serial data link and the display link;
immediately after a pre-emptive event associated with docking of the host computer, the dock management controller to transmit a command to the display link using the virtual control panel protocol to activate the display device.

2. The docking station of claim 1, wherein the pre-emptive event comprises one of the host computer being docked to the electronic device, the host computer being activated from a sleep state while docked, the host computer being cold boot while docked, and the docking station receiving a wireless signal from the host computer to be docked.

3. The docking station of claim 1, further comprising a video output controller communicably coupled to the dock management controller through the serial data link.

4. The docking station of claim 3, wherein the command is transmitted from the dock management controller to the display link through the video output controller.

5. The docking station of claim 1, wherein the serial data link comprises a I2C interface.

6. The docking station of claim 1, wherein the virtual control panel protocol is built on top of VESA standard DDC/CI protocol.

7. The docketing station of claim 1, wherein the dock management controller further comprises a memory to record a display connection profile that comprises information associated with the display device.

8. The docketing station of claim 8, wherein the dock management controller updates the display connection profile when the display device is disconnected from the docking station or when another display device is connected to the docking station.

9. The docketing station of claim 1, further comprising a detector to determine that the host computer is in close proximity to the docking station.

10. A docking station, comprising:
a host link communicable with a host computer;
a display link communicable with a display device;
a dock management controller comprising a serial data link and a memory to record a display connection profile comprising information associated with the display device; and
a virtual control panel protocol to facilitate direct communications between the serial data link and the display link;
immediately after a pre-emptive event associated with docking of the host computer, the dock management controller to transmit a command to the display link using the virtual control panel protocol to activate the display device.

11. The docking station of claim 10, wherein the pre-emptive event comprises one of the host computer being docked to the electronic device, the host computer being activated from a sleep state while docked, the host computer being cold boot while docked, and the docking station receiving a wireless signal from the host computer to be docked.

12. The docking station of claim 10, further comprising a video output controller communicably coupled to the dock management controller through the serial data link, wherein the command is transmitted from the dock management controller to the display link through the video output controller.

13. The docketing station of claim 10, wherein the dock management controller updates the display connection profile when the display device is disconnected from the docking station or when another display device is connected to the docking station.

14. The docketing station of claim 10, further comprising a detector to determine that the host computer is in close proximity to the docking station.

15. A docking station, comprising:
a host link communicable with a host computer;
a display link communicable with a plurality of display devices;
a dock management controller comprising a serial data link and a memory that records a display connection profile comprising information associated with the display devices;
a video output controller communicably coupled to the dock management controller through the serial data link, the video output controller capable of receiving video signals from the host computer via the host link and transmitting the video signals via the display link to the display devices connected to the docking station; and
a virtual control panel protocol to facilitate direct communications between the serial data link and the display link;
immediately after a pre-emptive event associated with docking of the host computer to the docking station, the dock management controller to transmit a command in accordance with the display connection profile to the display link using the virtual control panel protocol so as to activate the display devices.
